(19) United States
(12) Patent Application Publication
(10) Pub. No.: US 2025/0104031 A1
(43) Pub. Date: Mar. 27, 2025

(54) PAYMENT REMINDER MANAGEMENT FOR ELECTRONIC DEVICES

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); HARIPRASAD SHANBHOGUE ALAMPADY, BANGALORE (IN)

(21) Appl. No.: 18/472,632

(22) Filed: Sep. 22, 2023

(51) Int. Cl. G06Q 20/10

(52) U.S. Cl. CPC G06Q 20/102

(57) ABSTRACT

A method provides techniques for managing payment reminders for electronic devices. The method includes receiving, by an electronic device comprising a display, a first notification corresponding to completion of a payment for a first bill. The method continues with subsequently detecting a second notification to make payment for the first bill, and identifying that the second notification corresponds to the first bill that has already been paid. In response to identifying that the second notification corresponds to the first bill that has already been paid, the method further includes suppressing presentation of the second notification on the display as a duplicate bill alert.

### BACKGROUND

### 1. Technical Field

The present disclosure generally relates to portable electronic communication devices, and more specifically to handling of payment reminders for portable electronic communication devices.

### 2. Description of the Related Art

Smartphones have become an integral part of daily life and provide a wide range of functionality. This functionality can include communication via voice calls, text messages, and/or other messaging applications (apps). Other popular functions of smartphones include gaming, navigation, ecommerce, online banking, health and fitness tracking, and more.

One area of smartphone usage that has seen growth in recent years is mobile payments. Mobile payments offer a wide range of benefits that have contributed to their growing popularity. One of the primary advantages of mobile payments is the convenience they offer. Users can make payments anytime, anywhere, as long as they have their mobile device and a connection to a communication network. This eliminates the need to carry physical cash or credit/debit cards. Device users often utilize one or more payment apps to complete payments to vendors. These apps present independent payment methods that can each provide a different benefit when used for paying an invoice or bill.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of a communication device with specific components used to enable the device to detect and respond to payment reminders for previously paid bills, and within which various aspects of the disclosure can be implemented, according to one or more embodiments;

FIG. 2A is a diagram illustrating an example of a notification of a payment reminder for an unpaid bill, using a first payment application;

FIG. 2B is a diagram illustrating an example of a later-in-time notification of a paid bill using a first payment application, to pay the bill referenced in FIG. 2A;

FIG. 2C is a diagram illustrating an example of a subsequently received notification by a second payment application of a reminder to pay the same bill shown in FIG. 2A;

FIG. 2D is a diagram illustrating an example of a notification by a second payment application of a reminder to pay a partial payment for the same bill shown in FIG. 2A;

FIG. 3 is a diagram illustrating an example of a notification that indicates that an identified bill has been paid, according to one or more embodiments;

FIG. 4A is a diagram illustrating an example of a payment reminder email that whose subject has been modified to indicate that the email notification corresponds to a bill that has already been paid, according to one or more embodiments;

FIG. 4B is a diagram illustrating an example of a payment reminder text message that has been modified to indicate that the text notification corresponds to a bill that has been paid, according to one or more embodiments; and

FIG. 5 depicts a flowchart of a method by which an electronic communication device operates a payment reminder management module to minimize duplication of payment reminders from different payment sources, according to one or more embodiments.

### DETAILED DESCRIPTION

According to aspects of the disclosure, an electronic (communication) device, a method, and a computer program product provide a payment reminder management feature of for the electronic device for identifying and/or suppressing duplicate payment reminders of an invoice that has been paid. The processor of the electronic device detects a first notification indicating completion of payment of a bill. Subsequently, the processor detects a second notification (e.g., from another payment service) indicating payment is required for the same bill that has already been paid, as indicated in the first notification. In response to detecting that the second notification corresponds to a bill that has already been paid, disclosed embodiments provide a duplicate bill alert and may further include an option to suppress future payment notifications for that bill. Thus, disclosed embodiments provide a user-configured option to activate a suppress-duplicate-bill-notification (SDBN) feature on an electronic device, thereby simplifying management of mobile payments utilizing multiple mobile payment services. Throughout this disclosure, the terms ‘electronic device,’ ‘communication device,’ and ‘electronic communication device’ may be used interchangeably, and may refer to devices such as smartphones, tablet computers, and/or other computing/communication devices.

An increasingly large number of users use their mobile devices (e.g., smartphones, tablets, and the like) for financial operations such as ecommerce, banking, trading stocks and other securities, and so on. Capitalizing on this trend, numerous mobile payment services have arisen in recent years. These mobile payment services can interface with various venders associated with a user, such as utility companies, service providers, and so on. The mobile payment services may be able to automatically retrieve outstanding bills from vendors using application programming interface (API) calls to retrieve the information from a server that contains vendor bill data. These mobile payment services may compete with each other for users, and encourage users to pay bills using their particular payment service. Also, these mobile payment services may offer incentives for a user to use a given mobile payment service. These incentives can include reward points, cash refunds, and/or other incentives. The mobile payment landscape has thus created a situation where users may have multiple mobile payment services, and the user may elect to use a given mobile payment service based on the incentives the particular service is currently offering. As an example, a user may typically pay a utility bill using a first mobile payment service. However, a second mobile payment service may offer a particular incentive, causing the user to use the second mobile payment service to pay the utility bill. The first payment service may not have the information that the bill was paid using another service, and the first payment service may send notifications to the user informing the user that he/she needs to pay a bill, when in fact the bill has already been paid. This surfacing of later payment reminder notifications, after payment of the bill, can lead to confusion, missed payments, duplicate payments, and/or other inconveniences.

The disclosed embodiments mitigate the aforementioned problems by managing payment reminders for bills that have already been paid. In one or more embodiments, a payment reminder management module (PRMM) is provided on the electronic device and enables the electronic device to keep track of payment information for a given bill. The embodiments may include processing incoming notifications regarding bill payment and extracting payment metadata from the notifications. The payment metadata can include, but is not limited to, paid date, due date, amount paid, payee, and payment service/application. The payment metadata can be stored in memory within the electronic device. When a subsequent notification is received by the electronic device, the notification is analyzed to determine if the notification is a payment reminder. If the notification is determined to be a payment reminder is, then payment metadata from the subsequent notification is extracted and checked against payment metadata for paid bills. In response to the subsequent metadata substantially matching the metadata from the paid bill, the electronic device can provide a duplicate bill alert for the user, as well as an option to suppress presentation of subsequent notifications corresponding to that bill. Accordingly, disclosed embodiments can enhance the effectiveness of multiple mobile payment applications.

According to aspects of disclosed embodiments, the electronic communication device includes at least one display that renders content from various applications, and the display also renders notifications and messages, etc. The electronic device also includes a memory having stored thereon a payment reminder management module (PRMM) with program code for monitoring for notifications, determining that the notifications correspond to a paid bill or a reminder to pay a bill. The PRMM may include program code for storing, on the device and/or cloud-hosted storage, a record of received payment metadata. When a subsequent notification is received by the electronic device, the PRMM can cause an electronic device to suppress presentation of the notification if the electronic device determines that the notification pertains to a bill that has previously been paid. As an example, a user can pay an electric bill for the month of June with a first mobile payment application on June 25. On June 26, a second mobile payment application may send a notification to the electronic device to remind the user to pay that same bill. The PRMM extracts payment metadata, such as the payment amount, payee, due date, and/or other payment metadata, and compares the extracted metadata to metadata for bills that have already been paid. The PRMM enables the electronic device to identify the notification from the second mobile payment application as corresponding to a bill that has previously been paid by the first mobile payment application. Accordingly, in one or more embodiments, the processor suppresses the notification from the second payment application, so that the user does not see the notification from the second payment application regarding the bill that has already been paid. In this way, payment issues such as accidentally paying a bill twice due to multiple notifications from different mobile payment services is mitigated.

One or more embodiments include an electronic device with specific components used to enable the device to detect and respond to payment reminders for previously paid bills. Embodiments can include an electronic device including a display; a memory storing instructions for a payment reminder management module; and a processor communicatively coupled to the display and the memory. The processor executes the instructions of the payment reminder management module, which causes the processor to: receive a first notification corresponding to completion of a payment for a first bill; subsequently detect a second notification to make payment for the first bill; identify that the second notification corresponds to the first bill that has already been paid; and in response to identifying that the second notification corresponds to the first bill that has already been paid, suppress presentation of the second notification on the display as a duplicate bill alert.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

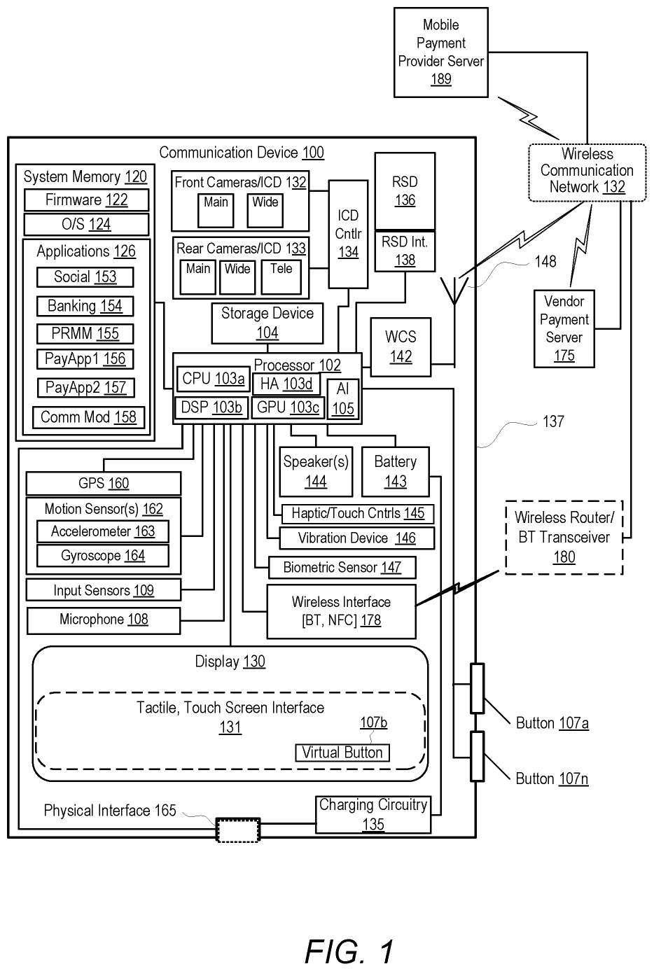

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, with specific components used to enable the device to detect and respond to payment reminders for previously paid bills, and within which various aspects of the disclosure can be implemented, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device. It is appreciated that electronic device 100 can include other types of electronic devices that enable payment of bills via mobile payment services.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124.

Processor 102 can, in some embodiments, include image signal processors (ISPs) (not shown) and dedicated artificial intelligence (AI) engines 105. Processor 102 is communicatively coupled to storage device 104, system memory 120, input devices (introduced below), output devices, including integrated display 130, and image capture device (ICD) controller 134. According to one or more embodiments, ICD controller 134 performs or supports functions such as, but not limited to, selecting and activating an active camera from among multiple cameras and adjusting the camera settings and characteristics (e.g., shutter speed, f/stop, ISO exposure, zoom control, field of view (FOV) angle, etc.) of the active camera. ICD controller 134 can perform these functions in response to commands received from processor 102 in order to control ICDs 132, 133 to capture video or still images of a local scene within a FOV of the operating/active ICD.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display. Processor 102 can also be generally referred to as controller 102.

Throughout the disclosure, the term image capturing device (ICD) is utilized interchangeably to be synonymous with and/or refer to any one of front or rear facing cameras 132, 133. Front facing cameras 132 and rear facing cameras 133 are communicatively coupled to ICD controller 134, which is communicatively coupled to processor 102. Both sets of cameras 132, 133 include image sensors that can capture images that are within the field of view (FOV) of the respective ICD 132, 133.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, social media application 153, banking application 154, payment reminder management module (PRMM) 155, a first mobile payment application 156, a second mobile payment application 157, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing of the different modules. For example, PRMM 155 includes program instructions that support electronic device 100 being configured to identify that a second notification corresponds to a first bill that has already been paid, and to suppress presentation of the second notification on the display as a duplicate bill alert. Thus, in embodiments, PRMM 155 can serve to enhance the effectiveness of mobile payment reminders generated by multiple payment services on electronic device 100.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device. RSD 136 may have a version of one or more of the applications (e.g., 153, 154, 155, 156, 157, 158) and specifically PRMM 155 stored thereon. Processor 102 can access RSD 136 to provision electronic device 100 with program code that, when executed/processed by processor 102, the program code causes or configures processor 102 and/or generally electronic device 100, to provide the various payment reminder management functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 107b. In embodiments, when a user applies a finger on the touch screen interface 131 in the region demarked by the virtual button 107b, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons 107a-107n. Microphone 108 can also be referred to as an audio input device. In some embodiments, microphone 108 may be used for identifying a user via voiceprint, voice recognition, and/or other suitable techniques. Input buttons 107a-107n may provide controls for volume, power, and ICDs 132, 133. Additionally, electronic device 100 can include input sensors 109 (e.g., enabling gesture detection by a user).

Electronic device 100 further includes haptic touch controls 145, vibration device 146, fingerprint/biometric sensor 147, global positioning system (GPS) device 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user, and in some embodiments, the biometric sensor 147 can supplement an ICD (camera) for user detection/identification.

GPS device 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be coupled to charging circuitry 135 and device battery 143 to enable recharging of device battery 143.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 132 and with other devices, such as server 175, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 132 via transmissions of communication signals to and from network communication devices, such as base stations or cellular nodes, of wireless communication network 132. Wireless communication network 132 further allows electronic device 100 to wirelessly communicate with vendor payment server 175 and/or mobile payment provider server 189, which can be similarly connected to wireless communication network 132. In one or more embodiments, the financial and other transactions that are being performed on communications device 100 can be supported using or completed via/on application/business server 175 and/or mobile payment provider server 189. In one or more embodiments, each mobile payment provider may be associated with a corresponding mobile payment provider server 189. The mobile payment provider server 189 may utilize application programming interface (API) calls to retrieve payment information from one or more vendor payment servers 175, where the payment information includes information pertaining to unpaid bills.

Electronic device 100 can also wirelessly communicate, via wireless interface 178, with wireless communication network 132 via communication signals transmitted by short range communication device(s) to and from an external WiFi router (or wireless transceiver device) 180, which is communicatively connected to wireless communication network 132. Wireless interface 178 can be a short-range wireless communication component providing Bluetooth, near field communication (NFC), and/or wireless fidelity (Wi-Fi) connections. In one embodiment, electronic device 100 can receive Internet or Wi-Fi based calls, text messages, multimedia messages, and other notifications via wireless interface 178. In one or more embodiments, electronic device 100 can communicate wirelessly with external wireless transceiver device 180, such as a WiFi router or BT transceiver, via wireless interface 178. In an embodiment, WCS 142 with antenna(s) 148 and wireless interface 178 collectively provide wireless communication interface(s) of electronic device 100.

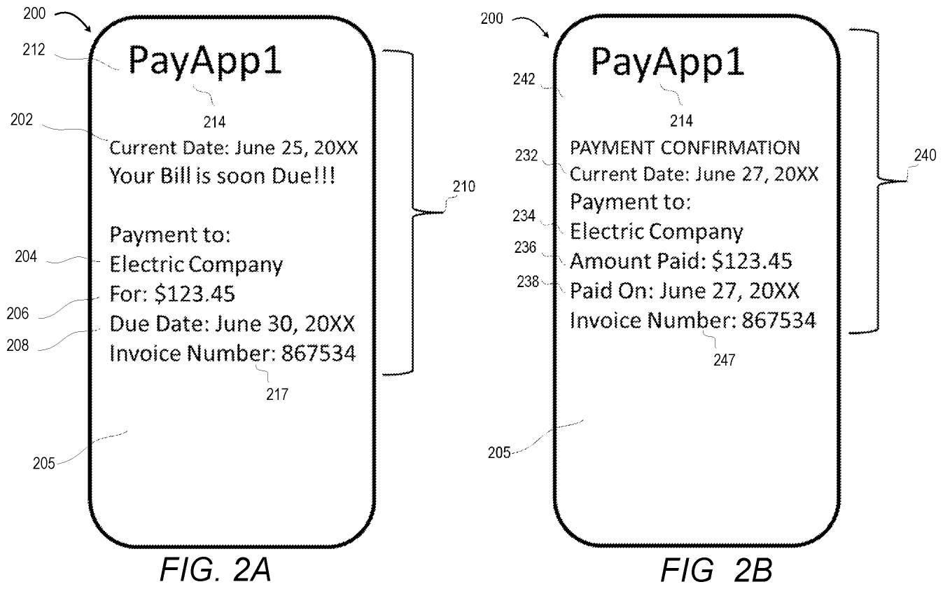

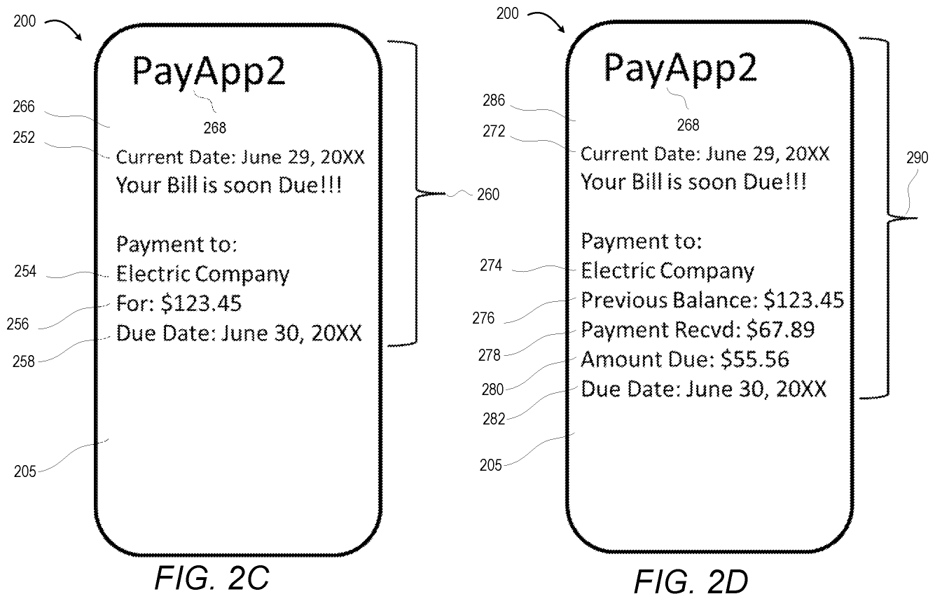

FIG. 2A is a diagram illustrating an example of a payment reminder notification from a first payment application for an unpaid bill. FIG. 2A includes electronic device 200, which can be an implementation of electronic device 100, having similar components and/or functionality. Device 200 includes display 205. Rendered on display 205 is a payment reminder notification 212 received from a first mobile payment provider 214, which corresponds to a first payment service/application. Payment reminder notification 212 includes payment metadata 210. The example payment metadata 210 includes a current date 202, which is the date that the payment notification is received by the electronic device. The payment metadata 210 further includes a payee 204, which is a name and/or other identifier corresponding to an entity receiving the payment. The payment metadata 210 further includes an amount due 206 and a due date 208. In one or more embodiments, the payment metadata can also include an invoice number 217 assigned to the bill by the vendor (e.g., the payee).

FIG. 2B is a later-in-time presentation of the display 205 of electronic device 200 that is presented in FIG. 2A. FIG. 2B is a diagram illustrating an example of a receipt notification of payment of a bill (i.e., a “paid bill notification” or “payment confirmation notification”) using the first payment service/application, PayApp1 214. Rendered on display 205 is a payment receipt notification 242 received from the first mobile payment provider 214, which corresponds to the first payment service/application and provides confirmation of a payment made using first mobile payment provider 214. Payment receipt notification 242 (referenced herein as a first notification, which triggers the PRMM processing) includes first payment metadata 240, which can be an extended version of payment metadata 210 to include payment details for the completed payment. The example first payment metadata 240 includes a current date 232, which is the date that the payment receipt notification is received by the electronic device. Current date 232 can be the same data as current date 202 (FIG. 2A) on which the payment reminder notification 212 (FIG. 2A) was received. The first payment metadata 240 further includes the payee 234, an amount paid 236, a due data 208, and a paid-on date 238. The paid-on date 238 can serve as an identification criterion to determine that the bill has already been paid. In one or more embodiments, the first payment metadata (240), which is generated in response to payment of the bill, comprises one or more of paid date, amount paid, and payee, and can include the identification of the payment service/application, such as indicated at 214. In one or more embodiments, the first payment metadata can also include the invoice number 247 of the original bill and a transaction receipt number.

FIG. 2C is a diagram illustrating an example of a subsequently received reminder notification from a second payment service/application reminding the user to pay the same bill shown in FIG. 2A. As depicted in FIG. 2C, rendered on display 205 of device 200 is payment metadata 260, which includes a payment reminder notification 266, received from a second mobile payment provider 268, on a current date 252 that is after the paid-on date 238 on which payment receipt notification 242 is received for first mobile payment provider 214 on device 200. Subsequently received payment reminder notification (referred to as a second notification, corresponding to the already paid invoice for which the first payment receipt notification has been received) includes second payment metadata 260. The second payment metadata includes a current date 252, which is the date that the notification is received by the electronic device. The second payment metadata 260 further includes a payee 254, which is a name and/or other identifier corresponding to an entity that would be requesting the payment if the payment is outstanding (i.e., the payee). The second payment metadata 260 further includes an amount due 256 and a due date 258. In one or more embodiments, the second payment metadata 260 can also include an invoice number assigned to the bill.

Continuing from the example starting in FIG. 2A, it can be seen that there are similarities between the payment metadata in payment notification 212 and payment notification 266. These similarities include the due date 258, which is the same as the due date 208 of FIG. 2A, the payee 254, which is the same as the payee 204 of FIG. 2A, and the amount due 256, which is the same as the amount paid 238 of FIG. 2B. The PRMM (155 of FIG. 1) enables the electronic device to perform a payment metadata comparison between payment metadata of payment notification (paid bill notification) 242 of FIG. 2B and payment notification 266, and determines, based on the similarities in the metadata, that payment notification 266 corresponds to the same bill referenced in (paid bill notification) 242. Furthermore, the PRMM determines that the bill is already paid, based on the presence of paid-on date 238 in the payment metadata for payment notification 242. In response to identifying that the second notification corresponds to the first bill that has already been paid, the PRMM can initiate one or more mitigation actions, as will be further described herein.

FIG. 2D is a diagram illustrating an example of a notification by a second payment application of a reminder to pay a partial payment for the same bill shown in FIG. 2A. As depicted in FIG. 2D, rendered on display 205 of device 200 is payment metadata 290, which includes a payment reminder notification 286, received from a second mobile payment provider 268, on a current date 272, a payee 274, a previous balance 276, a payment received 278, an amount due (remaining balance) 280, and a due date 282. In embodiments, a partial payment, resulting in a remaining balance, is treated as an unpaid bill, and notifications for payment continue to surface as normal.

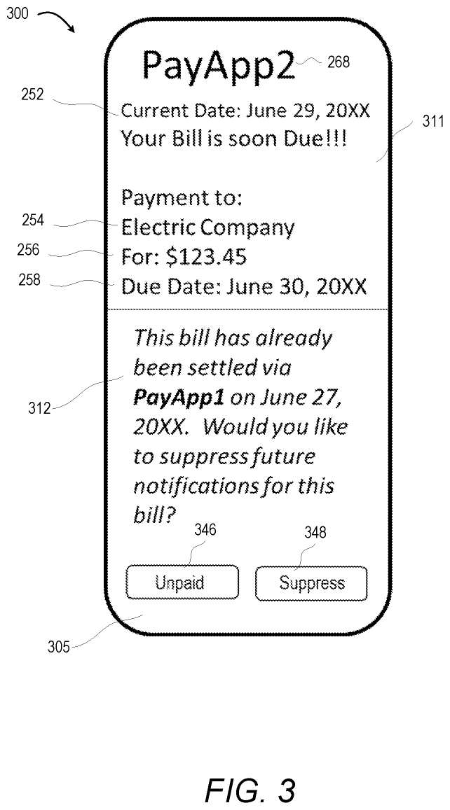

FIG. 3 is a diagram illustrating an example of a modified notification, which is a received notification that has been modified to indicate that the received notification corresponds to a paid bill, according to one or more embodiments. The example depicted in FIG. 3 continues from the example shown in FIG. 2A and FIG. 2B, in which FIG. 3 illustrates additional features provided by one or more disclosed embodiments. FIG. 3 includes electronic device 300, which is the same as device 200 of FIG. 2C, with the modified version of the received payment notification. Device 300 includes display 305. Rendered on display 305 is a modified payment notification 311, which includes content of payment notification 266 from the second mobile payment provider 268 as shown in FIG. 2C), which includes payment metadata. Similar to FIG. 2C, the payment metadata includes the current date 252, a payee 254, an amount due 256 and a due date 258. There are similarities between the payment metadata shown in FIG. 3 and the payment metadata shown in FIG. 2A and FIG. 2B. These similarities include the due date 258, which is the same as the due date 208 of FIG. 2A, the payee 254, which is the same as the payee 234 of FIG. 2B, and the amount due 256, which is the same as the amount paid 236 of FIG. 2B.

Continuing from the example shown in FIG. 2A, based on the previously described similarities in the payment metadata between FIG. 3 and FIG. 2B and the additional payment detail from payment metadata 240 (FIG. 2B) indicating that the bill has been paid, the PRMM causes the electronic device to display an indication 312 that the received notification corresponds to a paid bill. Thus, indication 312 serves as a duplicate bill alert. The indication 312 can further include an option 346 to mark the first bill as unpaid and/or an option 348 to suppress future notifications for the first bill (i.e., the bill referenced in FIG. 2A). Option 346 and option 348 can be implemented as virtual buttons on display, which when pressed, tapped, clicked, or otherwise selected by a user, cause the PRMM to cause the electronic device to record a user preference for the corresponding bill in the memory of the electronic device. Future notifications corresponding to that bill are then processed based on the user preference. That is, if the user preference is option 348, then future notifications corresponding to that bill are suppressed. Conversely, if the user preference is option 346, then future notifications corresponding to that bill are surfaced (e.g., presented to the user via the display 305).

One or more embodiments of the disclosure can include collecting and storing first payment metadata corresponding to the first bill from the first notification received following bill payment; providing an option to suppress future notifications for the first bill; and in response to detecting that the option to suppress future notifications is activated, suppressing future notifications pertaining to the first bill, based on the first payment metadata matching payment metadata from the future notifications. One or more embodiments can further include providing an option to mark the first bill as unpaid; and in response to detecting selection of the option to mark the first bill as unpaid, surfacing future notifications pertaining to the first bill. The option 346 for marking a bill as unpaid can be useful for allowing a user to override the logic that is enabled by the PRMM. As an example, a user could make a payment with a first mobile payment application, and a payment notification indicating that the bill is paid can be received by the electronic device. In a circumstance such as insufficient funds or a network error, it can turn out that the bill in fact did not get paid. With the feature provided by option 346, a user can override the PRMM, allowing notifications for that bill to continue to be surfaced, with no ‘duplicate payment’ alert applied thereto. Another circumstance well-suited for option 346 is the scenario of partial payments. In the event that a bill is partially paid, the resultant payment notification could include text that could possibly cause the logic enabled by the PRMM to indicate a bill is paid when in fact that bill is only partially paid. Option 346 enables a user to continue to indicate that the bill is not paid, allowing the payment notifications for that bill to continue to be surfaced as they arrive.

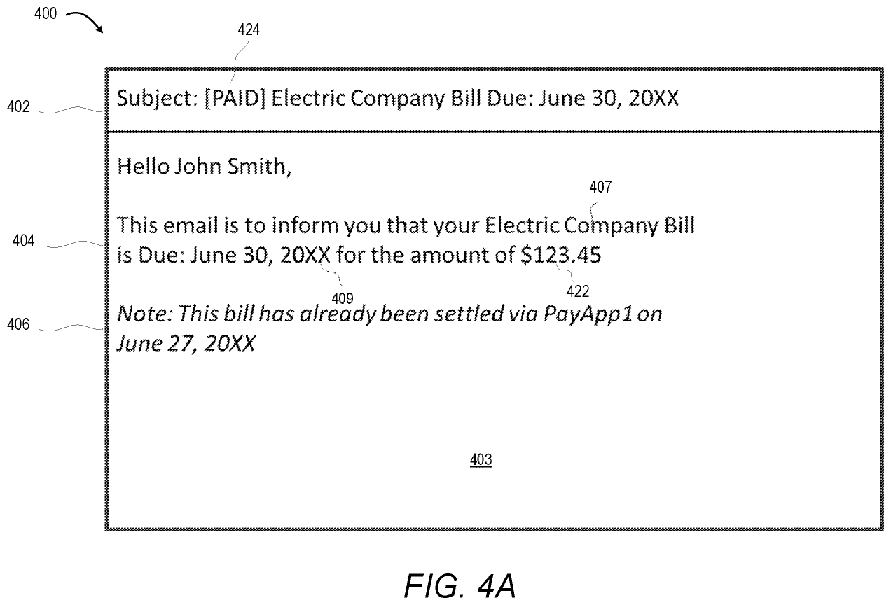

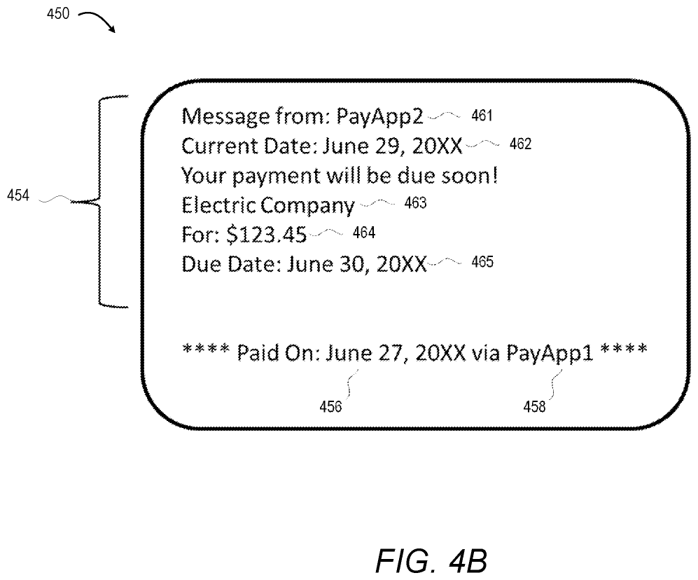

FIG. 4A is a diagram illustrating an example of an email that indicates that a received payment notification corresponds to a paid bill, according to one or more embodiments. Payment notifications can be delivered to an electronic device via a variety of techniques, including, but not limited to, application messages, SMS text messages, and/or email messages. FIG. 4A shows an example of a payment notification email message 400. Message 400 includes a subject line 402, and a body field 403. Body field 403 includes a payment notification 404. Payment notification 404 includes payment metadata. The payment metadata includes payee 407, an amount owed 422, and a due date 409. Continuing with the example started in FIGS. 2A-2C, the payment metadata is similar to payment metadata found in payment notification 212 of FIG. 2A. More specifically, payee 407 is the same as payee 204 of FIG. 2A, amount due 422 is the same as amount 236 of FIG. 2B, and due date 409 is the same as due date 208 of FIG. 2A. Accordingly, the PRMM causes the electronic device to insert information into the message 400 to provide an indication that the email-based payment notification corresponds to a paid bill. In the illustrative embodiment, the inserted information includes adding a paid status indication 424 to the subject line 402 of the email message and also including paid status information 406 in the body field 403 of the email message 400. It is appreciated that other implementations can provide only one paid status information within either the subject or the body of the email. One or more embodiments of the disclosure can thus include adding a paid status indication to a subject line of the email message and/or include paid status information in a body of the email message. In one or more embodiments, the email application can be configured to suppress the second notification which is received as an email. In one or more embodiments, a suppressed mail folder is created within the email directory of folders. Then, to suppress the second notification, the processor routes the email message that is identified as pertaining to a paid bill/invoice into the suppressed mail folder. Further, in one or more embodiments, to present an indication of a paid status of the bill on the display, the processor adds a paid status indication to a subject line of the email message and includes paid status information in a body of the email message. Accordingly, disclosed embodiments can augment an email message to include an indication that the email message corresponds to a bill that has previously been paid.

FIG. 4B is a diagram illustrating an example of a text message that indicates that a received text includes a payment notification that corresponds to a paid bill, according to one or more embodiments. Text message 450 includes original text content 454. The original content includes payment metadata. The payment metadata includes fields indicating a payment service/application 461, a current date 462, a payee 463, an amount due 464, and a due date 465. As previously described, the payment metadata in the text message 450 can be compared with payment metadata for previously received notifications pertaining to paid bills. In response to determining that the text message 450 is a payment notification that corresponds to a paid bill, the PRMM can cause the processor to add paid status information 456 to the displayed text message 450. In one or more embodiment, the paid status information 456 includes payment service/application 458 that was used to make the payment. Additionally, in one or more alternate embodiments, the processor can be programmed to suppress the text message and route the text message to a suppressed message entry (or folder) created within user interface of the text message app. Unlike a standard text entry that surfaces received text messages as a notification on the electronic device or as an unread entry within the list of received text messages, suppressed message entry/folder can be muted (not highlighted) and can require a user to search for the entry/folder in order to access the messages within the entry. In this way, text messages that include notifications to pay a bill that has already been paid do not sit atop the text message entries as an unread entry within the listing of received text messages, and the automatic notification of the text message is suppressed, so as not to require the user to dedicate time towards opening and reading the message. However, the user still has the option to view the messages by searching for and opening the suppressed message entry/folder at a later time.

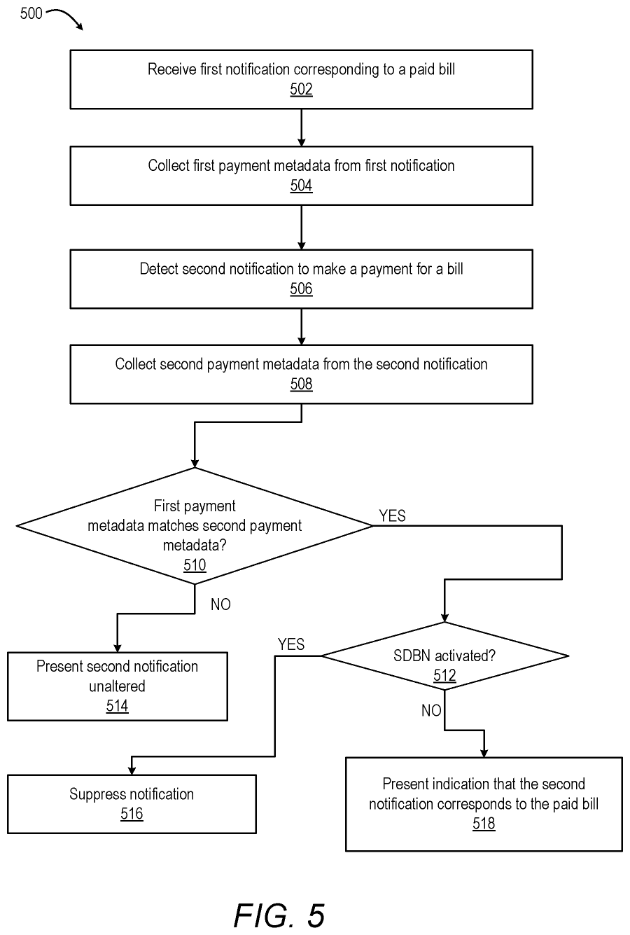

Referring now to the flowchart, FIG. 5 is a flowchart presenting an embodiment of a method 500 by which an electronic device detects, and responds to, payment notifications for bills that have previously been paid. The response to these duplicate payment notifications can include suppression of duplicate payment notifications or surfacing of the paid status notification along with providing an option for a user to suppress future payment notifications pertaining to the given bill. The response can also include providing an option for a user to mark a bill as unpaid so as not to suppress future notifications for payment.

The descriptions of the methods in FIG. 5 are provided with general reference to the specific components and features illustrated within the preceding FIGS. 1-4B. Specific components referenced in the methods of FIG. 5 may be identical or similar to components of the same name used in describing preceding FIGS. 1-4B. In one or more embodiments, processor 102 (FIG. 1) configures electronic device 100 (FIG. 1) to provide the described functionality of the methods of FIG. 5 by executing program code for one or more modules or applications provided within system memory 120 of electronic device 100.

FIG. 5 depicts a flowchart of a method 500 by which an electronic device detects, analyzes, and evaluates whether to present or suppress payment notifications received from multiple mobile payment providers. At block 502, a first notification is received that corresponds to a paid bill. The first notification can include an in-app notification, a text message, an email message, and/or other suitable notification type. At block 504, first payment metadata is collected from the first notification. The first payment metadata can include, but is not limited to, a payee name, a mobile payment service name, an amount paid, a due date, a paid-on date, an invoice number, an account number, a payer name, and/or other metadata fields. In one or more embodiments, the payment metadata is extracted from the notification via natural language processing (NLP), template matching, regular expression (regex) matching, and/or other suitable techniques. At block 506, a second notification for the bill is detected. The method 500 continues to block 508, where second payment metadata from the second notification is collected.

The method continues to block 510, where a check is made to determine if the first payment metadata matches the second payment metadata. One or more embodiments can include collecting and storing first payment metadata corresponding to the first bill from the first notification; collecting second payment metadata from a subsequently received second notification for payment of a bill; comparing the first payment metadata to the second payment metadata for a match; and determining that the second notification corresponds to the first bill in response to the first payment metadata substantially matching the second payment metadata. In one or more embodiments, comparing the first payment metadata to the second payment metadata for a match comprises comparing one or more of invoice number, and comparing of an amount paid in the first payment metadata to an amount due in the second payment metadata. Additional comparisons can include payee, and payment service/application. The matching can include performing a string compare operation, numeric compare operation, and/or other comparisons to determine if the first payment metadata matches the second payment metadata. In one or more embodiments, a hash of one or more pieces of metadata is computed and stored for use in comparisons. As an example, a hash of the invoice number, paid amount paid, payee name, and due date can be generated for a paid bill. When subsequent payment notifications are received, a second hash of the invoice number, amount due, payee name, and due date can be computed for each subsequent notification and the second hash can be compared to the hash of the payment metadata corresponding to the paid bill. In this way, one comparison can be made to determine if multiple payment metadata fields match. In embodiments, the hash can be computed as an md5 hash, sha256 hash, or other suitable hashing technique.

With the above computation/generation of a hash, for embodiments in which the payment notification for the paid bill (paid bill notification) has a paid amount that is less than the amount due, the generated hash would not be the same as the second hash. In these scenarios, the payment reminder notification would still be surfaced for the user to be reminded that not all of the bill was paid. However, in one or more embodiments, the payment reminder notification would be modified to include additional information corresponding to the paid bill notification, such as the amount paid, the date paid, the payee service utilized, and a computed balance remaining. The modified payment reminder notification thus alerts the user of the outstanding balance and the initial payment service used, which could potentially enable the user to revert to the initial payment service in order to maintain a cohesive record of all payments made for the single bill to the same payee.

In one or more embodiments, fuzzy matching techniques may be utilized on one or more payment metadata field comparisons. In particular, a payee name may sometimes be entered slightly differently on different mobile payment systems. As an example, an electric company utility may be entered as “Electric Company” on a first mobile payment system and “Elec Co” on a second mobile payment system. Disclosed embodiments may utilize fuzzy text matching to determine, with some level of confidence, that payment metadata corresponds to the same payee. The fuzzy text matching can employ distance metrics or similarity measures that quantify how similar two strings are. These metrics assign a numerical value to represent the difference between strings, such as payee names retrieved from payment metadata. The distance metrics can include a hamming distance, Jaccard similarity, Cosine similarity, and/or other suitable distance metrics. Once the distance metric is calculated, a threshold is set to determine whether two strings (e.g., two payee names) are considered similar enough. In some embodiments, a similarity score can be assigned based on the distance metric. In one or more embodiments, the lower the distance (or the higher the similarity score), the more similar the strings are considered. Accordingly, disclosed embodiments can employ fuzzy text matching to accommodate differences in entry of payee names in various mobile payment systems. Second metadata (e.g., payment due date) can be used to confirm a substantial “match” of a first metadata when only a partial matching of that first metadata (e.g., payee name) exists. As another example, if a partial invoice number is presented (e.g., first or last 4 digits) in one notification when the full invoice number is presented in the other notification, the partial matching can be substantiated by comparing the payee metadata and/or the due date metadata.

Returning to the flow chart, the method 500 continues to block 510. If, at block 510, it is determined that the first payment metadata does not match the second payment metadata, then the second notification is presented unaltered (block 514). If instead, at block 510, it is determined that the first payment metadata matches the second payment metadata, then the method 500 continues to block 512, where a check is made to determine if a suppress-duplicate-bill-notification (SDBN) feature is activated. If, at block 512, it is determined that the SDBN feature is activated, then the method 500 continues to block 516, where the notification is suppressed (not surfaced). In some embodiments, the SDBN feature is applied on a bill basis, such that duplicate notification suppression can be applied to each bill separately. In these embodiments, the first time a duplicate bill is detected, the corresponding notification is surfaced, along with an indication that the notification corresponds to a paid bill (e.g., 312 of FIG. 3), along with an option to suppress future reminders for that bill. In some embodiments, the SDBN feature can be applied on a global basis, such that any payment notification that is deemed to correspond to a previously paid bill is suppressed. Some embodiments may enable a user-configurable option for whether the SDBN feature operates in a global mode or a bill basis mode. In one or more embodiments, the second notification is a text message, and the method 500 further comprises routing the text message to a suppressed message folder and/or adding paid status information to the text message. In this way, a user can periodically check the suppressed message folder to review all incoming messages, while not being made to dedicate time to reading duplicate payment notifications being surfaced. The suppressed message folder can apply to email messages such as depicted in FIG. 4A, and/or text messages such as depicted in FIG. 4B.

If, at block 512, it is determined that the SDBN feature is not activated, then the method 500 continues to block 518, where the notification is presented, along with an indication that the notification corresponds to a paid bill, as depicted in FIG. 3, FIG. 4A, and FIG. 4B. One or more embodiments can include: identifying whether a suppress-duplicate-bill-notification (SDBN) feature is activated on the electronic device; performing the suppressing of the presentation of the second notification in response to the SDBN feature being activated; and in response to the SDBN feature not being activated, presenting, on the display, an indication that the second notification corresponds to a paid bill.

As can now be appreciated, the disclosed embodiments provide a feature of managing payment reminders being generated from multiple mobile payment applications. Thus, the disclosed embodiments avoid problems caused when using my multiple payment applications on a single user device, such as receiving too many (duplicate) reminders even after the bill has been paid using one of the applications. With too many mobile payment applications presenting the same bill to a user, unwanted messages and resulting user disruptions occur. The duplicate messages can lead to ‘alert fatigue,’ in which case, if a bill truly has not been paid, the user may miss the deadline for paying the bill due to treating the multiple notifications as a nuisance or false alarm. Additionally, if the level of duplicate alerts becomes too much of a nuisance, the user may turn off bill-related reminders, which can in turn result in missed payments due to not receiving any reminders. The disclosed embodiments mitigate the aforementioned issues by detecting and analyzing incoming payment notifications, suppressing duplicate notifications and/or providing alerts regarding payment corresponding to bills that have already been paid, as well as providing options to suppress future payment notifications that are duplicates. Accordingly, the disclosed embodiments improve the technical field of mobile payment applications.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a memory storing instructions for a payment reminder management module;
a processor communicatively coupled to the display and the memory and that executes the instructions of the payment reminder management module, which causes the processor to:
receive a first notification corresponding to completion of a payment for a first bill;
subsequently detect a second notification to make payment for the first bill;
identify that the second notification corresponds to the first bill that has already been paid; and
in response to identifying that the second notification corresponds to the first bill that has already been paid, suppress presentation of the second notification on the display as a duplicate bill alert.

2. The electronic device of claim 1, wherein to suppress presentation of the second notification on the display, the processor:
identifies whether a suppress-duplicate-bill-notification (SDBN) feature is activated on the electronic device;
performs the suppressing of the presentation of the second notification in response to the SDBN feature being activated; and
in response to the SDBN feature not being activated, presents, on the display, an indication that the second notification corresponds to a paid bill.

3. The electronic device of claim 2, wherein in addition to presenting an indication on the display, the processor:
collects and stores first payment metadata corresponding to the first bill from the first notification;
provides an option to suppress future notifications for the first bill; and
in response to detecting that the option to suppress future notifications is activated, suppresses future notifications pertaining to the first bill, based on the first payment metadata matching payment metadata from the future notifications.

4. The electronic device of claim 2, wherein in addition to presenting an indication on the display, the processor:
provides an option to mark the first bill as unpaid; and
in response to detecting selection of the option to mark the first bill as unpaid, surfaces future notifications pertaining to the first bill.

5. The electronic device of claim 2, wherein the second notification is a text message, and wherein:
to suppress the second notification, the processor routes the text message to a suppressed message folder; and
to present an indication on the display, the processor further adds paid status information to the text message.

6. The electronic device of claim 1, wherein the second notification is an email message, and wherein:
to suppress the second notification, the processor routes the email message to a suppressed mail folder; and
to present an indication on the display, the processor:
adds a paid status indication to a subject line of the email message; and
includes paid status information in a body of the email message.

7. The electronic device of claim 1, wherein to identify that the second notification corresponds to the first bill, the processor:
collects and stores first payment metadata corresponding to the first bill from the first notification;
collects second payment metadata from a subsequently received second notification for payment of a bill;
compares the first payment metadata to the second payment metadata for a match; and
determines that the second notification corresponds to the first bill in response to the first payment metadata substantially matching the second payment metadata.

8. The electronic device of claim 7, wherein the first payment metadata comprises one or more of paid date, amount paid, payee, and payment service/application.

9. A method comprising:
receiving, by an electronic device comprising a display, a first notification corresponding to completion of a payment for a first bill;
subsequently detecting a second notification to make payment for the first bill;
identifying that the second notification corresponds to the first bill that has already been paid; and
in response to identifying that the second notification corresponds to the first bill that has already been paid, suppressing presentation of the second notification on the display as a duplicate bill alert.

10. The method of claim 9, wherein suppressing presentation of the second notification comprises:
identifying whether a suppress-duplicate-bill-notification (SDBN) feature is activated on the electronic device;
performing the suppressing of the presentation of the second notification in response to the SDBN feature being activated; and
in response to the SDBN feature not being activated, presenting, on the display, an indication that the second notification corresponds to a paid bill.

11. The method of claim 10, further comprising:
collecting and storing first payment metadata corresponding to the first bill from the first notification;
providing an option to suppress future notifications for the first bill; and
in response to detecting that the option to suppress future notifications is activated, suppressing future notifications pertaining to the first bill, based on the first payment metadata matching payment metadata from the future notifications.

12. The method of claim 10, further comprising:
providing an option to mark the first bill as unpaid; and
in response to detecting selection of the option to mark the first bill as unpaid, surfacing future notifications pertaining to the first bill.

13. The method of claim 10, wherein the second notification is a text message, the method further comprising:
routing the text message to a suppressed message folder; and
adding paid status information to the text message.

14. The method of claim 9, wherein the second notification is an email message, the method further comprising:
adding a paid status indication to a subject line of the email message; and
including paid status information in a body of the email message.

15. The method of claim 9, wherein identifying that the second notification corresponds to the first bill comprises:
collecting and storing first payment metadata corresponding to the first bill from the first notification;
collecting second payment metadata from a subsequently received second notification for payment of a bill;
comparing the first payment metadata to the second payment metadata for a match; and
determining that the second notification corresponds to the first bill in response to the first payment metadata substantially matching the second payment metadata.

16. The method of claim 15, wherein comparing the first payment metadata to the second payment metadata for a match comprises comparing one or more of paid date, amount paid, payee, and payment service/application.

17. A computer program product comprising a non-transitory computer readable medium having program instructions that when executed by a processor of an electronic device that comprises a display, the program instructions configure the electronic device to perform functions comprising:
receiving a first notification corresponding to completion of a payment for a first bill;
subsequently detecting a second notification to make payment for the first bill;
identifying that the second notification corresponds to the first bill that has already been paid; and
in response to identifying that the second notification corresponds to the first bill that has already been paid, suppressing presentation of the second notification on the display as a duplicate bill alert.

18. The computer program product of claim 17, wherein the computer program product further comprises program instructions for:
identifying whether a suppress-duplicate-bill-notification (SDBN) feature is activated on the electronic device;
performing the suppressing of the presentation of the second notification in response to the SDBN feature being activated; and
in response to the SDBN feature not being activated, presenting, on the display, an indication that the second notification corresponds to a paid bill.

19. The computer program product of claim 18, wherein the computer program product further comprises program instructions for:
collecting and storing first payment metadata corresponding to the first bill from the first notification;
providing an option to suppress future notifications for the first bill; and
in response to detecting that the option to suppress future notifications is activated, suppressing future notifications pertaining to the first bill, based on the first payment metadata matching payment metadata from the future notifications.

20. The computer program product of claim 18, wherein the computer program product further comprises program instructions for:
providing an option to mark the first bill as unpaid; and
in response to detecting selection of the option to mark the first bill as unpaid, surfacing future notifications pertaining to the first bill.
